(19) United States
(12) Patent Application Publication
(10) Pub. No.: US 2023/0144585 A1
(43) Pub. Date: May 11, 2023

(54) MACHINE LEARNING MODEL CHANGE DETECTION AND VERSIONING

(71) Applicant: International Business Machines Corporation, Armonk, NY (US)

(72) Inventors: Shubhi Asthana, Santa Clara, CA (US); Shikhar Kwatra, San Jose, CA (US); Sushain Pandit, Austin, TX (US)

(21) Appl. No.: 17/524,020

(22) Filed: Nov. 11, 2021

(51) Int. Cl. G06F 9/445; G06N 20/00; G06K 9/62

(52) U.S. Cl. CPC G06F 9/44536; G06N 20/00; G06K 9/6202; G06K 9/6215; G06K 9/623

(57) ABSTRACT

Systems, methods, and computer programming products for versioning machine learning models. Changes between new and existing datasets are detected, quantified and compared using statistical and semantic feature comparisons. Recommendations for versioning existing models are in response to detecting changes between the feature importance of datasets used in the application of the machine learning model and new datasets that introduce new features or features that evolve over time in such a manner that feature importance has shifted away from one or more features of the first dataset to the new dataset. Based on the changes in feature importance, statistical changes and semantic feature comparisons, the recommendations provided describe whether models should be updated with a re-trained model, or that the existing features of the model do not indicate a need for re-training.

### STATEMENT REGARDING PRIOR DISCLOSURES BY INVENTOR OR JOINT INVENTOR

The following disclosure is submitted under 35 U.S.C. 102(b)(1)(A): DISCLOSURE: Shubhi Asthana, Shikar Kwatra and Sushain Pandit, “ML Model Change Detection and Versioning Service”, IEEE International Conference on Smart Data Services, submitted and accepted at the conference on Sep. 8, 2021.

### BACKGROUND

The present disclosure relates generally to the field of machine learning and artificial intelligence, and more specifically dynamically updating deployed machine learning models to ensure accurate predictions as changes to inputted data drift over time.

Machine learning is a branch of artificial intelligence (AI) and computer science which focuses on the use of data and algorithms to imitate the way that humans learn, gradually improving its accuracy. Machine learning is an important component of the growing field of data science. Through the use of statistical methods, algorithms are trained to make classifications or predictions, uncovering key insights within data mining projects. A machine learning model is a file that has been trained using dataset(s) to recognize certain patterns and/or provide the insights into the data. A model can be trained using the set of data and applying the dataset to an algorithm that can use reason over time to learn from the data. Once trained, the model can be used to apply reasoning to data that the model has not seen before and make predictions about the data. These insights subsequently drive decision making within applications and businesses. Over time however, patterns and relations within the data often evolve, thus, models built for analyzing such data can become obsolete over time, unless the models are adjusted and/or retrained. In machine learning and data mining, this phenomenon is referred to as concept drift.

### SUMMARY

Embodiments of the present disclosure relate to a computer-implemented method, an associated computer system and computer program products for versioning a machine learning model by detecting changes in feature importance of machine learning data sets and recommending whether to re-train a deployed machine-learning model. The computer-implemented method comprising: ingesting, by a versioning service, a first dataset configured to train the machine learning model; performing, by the versioning service, feature exploration of the first data set and extracting from the first dataset, feature importance (f₁) of the machine learning model; ranking, by the versioning service, top features of the first dataset used to train the machine learning model by the feature importance, up to a configured threshold number (n) of features; pre-processing, by the versioning service, features of a second dataset (f₂); comparing, by the versioning service, changes in features between f₁ and f₂ for up to the configured threshold number of features; and upon comparing, by the versioning service, the changes in the features between f₁ and f₂, and the changes between f₁ and f₂ are non-overlapping features: highlighting set (f₁−f₂) in f₁ which have an addition or deletion of categories within a feature and if the set (f₁−f₂) is ranked within the top features up to the configured threshold number of features for f₁, outputting, by the versioning service, a recommendation to re-train the machine learning model.

### BRIEF DESCRIPTION OF THE DRAWINGS

The drawings included in the present disclosure are incorporated into, and form part of, the specification. The drawings illustrate embodiments of the present disclosure and, along with the description, explain the principles of the disclosure. The drawings are only illustrative of certain embodiments and do not limit the disclosure.

FIG. 1A depicts a block diagram illustrating internal and external components of an embodiment of a computing system in which embodiments described herein may be implemented in accordance with the present disclosure.

FIG. 1B depicts a block diagram illustrating an extension of the computing system environment of FIG. 1A, wherein the computing systems are configured to operate in a network environment and perform methods described herein in accordance with the present disclosure.

FIG. 2 depicts a functional block diagram describing an embodiment of a computing environment for implementing a machine learning model change detection and versioning service that detects and quantifies changes across new and existing data sets, in accordance with the present disclosure.

FIG. 3 depicts a block diagram illustrating a cloud computing environment in accordance with the present disclosure.

FIG. 4 depicts an embodiment of abstraction model layers of a cloud computing environment in accordance with the present disclosure.

FIG. 5A depicts a flow diagram describing an embodiment of a method for implementing change detection and versioning of a machine learning model in accordance with the present disclosure.

FIG. 5B depicts a continuation of the flow diagram of FIG. 5A describing the method for implementing change detection and versioning of a machine learning model in accordance with the present disclosure.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The corresponding structures, materials, acts, and equivalents of all means or steps plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments chosen and described are in order to best explain the principles of the disclosure, the practical applications and to enable others of ordinary skill in the art to understand the disclosure for various embodiments with various modifications as are suited to the particular use contemplated.

Overview

Traditional machine learning workflow involves extracting data from data sources such as a data lake or data warehouse and using the extracted data to train the machine learning model to learn or recognize patterns. Models can first be trained offline and then used for predicting an output for test data the model has never seen before. To pursue a model with high fidelity and accuracy, machine learning models may need to be re-trained and exposed to the machine learning pipeline if new data has emerged or evolved over time and may need to be analyzed alongside historical data, to account for both long-term and short-term trends of the data. Moreover, as trends in the data change, entire concepts upon which an algorithm for training the machine learning model may need to shift in order to continue to make accurate predictions and provide relevant insights.

Embodiments of the present disclosure recognize that patterns and relationships in data can evolve over time. Models that are built for analyzing the constantly evolving data can become obsolete over time if the models are not updated to compensate for the changes in the data. Furthermore, embodiments disclosed herein also recognize there are several challenges that arise when it comes versioning a model. Firstly, model re-training is not simply limited to finding new features and/or observations within existing model architectures but can also comprise of excluding previously used features that may no longer be considered important. Versioning models can also significantly increase or decrease feature correlations and the parameter search space. Secondly, as new features are added to new datasets, the new features may or may not impact model performance. Retraining models can be costly if the additional features or observations within the new datasets do not add any value to the model. Therefore, it is important to data scientists and others responsible for the output of machine learning models to know whether or not to re-train a model as new datasets emerge.

Embodiments of the present disclosure alleviate the ambiguity when comes to deciding whether or not to re-train a machine learning based model by providing a versioning service that determines when a machine learning model requires versioning based on variations in the features between current datasets and new datasets, and changes in feature importance of the overlapping and non-overlapping features. Embodiments of the versioning service evaluate whether new features and changes in feature importance substantially change model predictions and accuracy. Embodiments of the versioning service extract feature importance of datasets (f₁) for the trained model. The extracted features may be extracted using an explainable artificial intelligence which may extract local and global importance from the dataset. Examples of explainable AI that may be used to extract feature importance may include permutation importance, LIME, Shapley Additive exPlanations (SHAP), and/or partial dependence plot (PDP). The versioning service may rank the top features of the f₁ in order by feature importance.

Embodiments of the versioning service may fetch new datasets from one or more data sources and pre-process the new features (f₂) found in the new datasets and compare changes in features for the top ranked features extracted from f₁ up to a configured threshold number of features (n) and/or a percentage of n feature (i.e., n %) with the pre-processed features of f₂. The top n or n % threshold may be defined by a user or administrator and may vary depending on the kinds of features and/or the coverage of the data set. The versioning service finds the changes (referred to as the “delta”) between the top n or n % features of f₁ and the features of f₂. In situations where feature importance for the top features extracted from the set of f₁ do not overlap with the features of set f₂, the features of set (f₁−f₂) is highlighted in f₁ which have an addition or deletion of categories within a feature. If the set of (f₁−f₂) falls within the configured threshold for the top n or n % of features in f₁ the versioning service may recommend re-training the machine learning model. Moreover, in situations where the feature set (f₁−f₂) does not fall within the threshold for the top n or n features of the set f₁, the features within the configured threshold of the top n or n % features may be stored within a feature store for re-usability at a later point in time.

In some embodiments of the versioning service, the versioning service may further evaluate feature correlation between the sets of f₁ and f₂, where new data has been received from the new dataset with a new feature set and attributes not previously found in f₁. For example, the versioning service may evaluate the correlations between the new features and/or attributes using cosine similarity and/or vector distance. Embodiments of the versioning service may take the value for the configured threshold of n or n % and compute feature overlap between f₁ and f₂ based on vector distance. If the feature overlap based on vector distance between features of f₁ and f₂ is significant, no re-training of the model may be recommended since there is less correlation between the features of f₁ and the new features of f₂. However, if the vector distance is insignificant or null, model re-training for the machine learning model may be recommended by the versioning service.

In some embodiments of the versioning service, further evaluation of the correlation between new features of f₂ and existing features of f₁ may be performed to identify semantical changes. For example, the correlation may be found by computing semantic distance between the features of f₁ and f₂. Using semantic distance may determine whether the new features present in f₂ represent a time-revise concept over an original feature that may have been present in the feature set of f₁. If overlap is observed between the new features of f₂ and the features of f₁ using semantic distance, the new features may be considered a time-revised concept over the original feature and a recommendation for re-training the model may be made. Otherwise, where the calculation of semantic distance does not indicate overlap between new features of f₂ and existing features of f₁, re-training of the model may not be recommended.

Computing System

The present invention may be a system, a method, and/or a computer program product at any possible technical detail level of integration. The computer program product may include a computer-readable storage medium (or media) having the computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus, or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

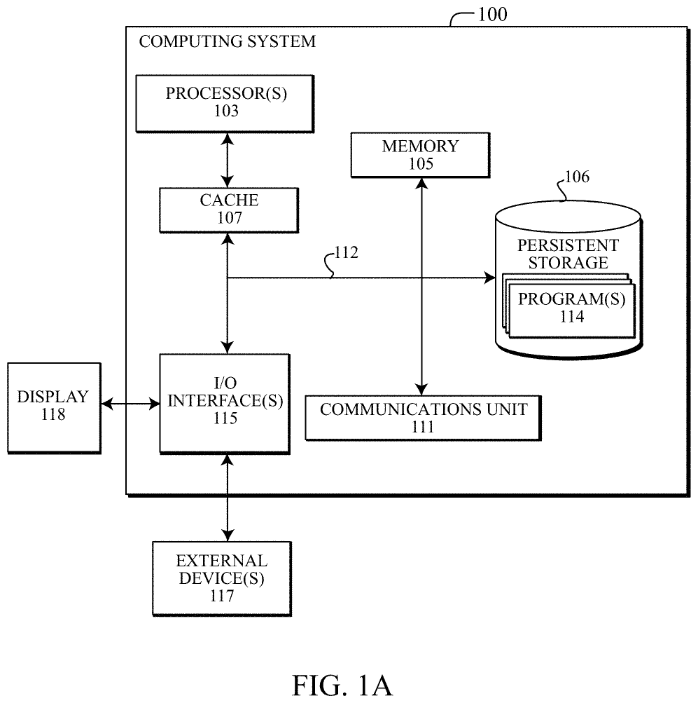

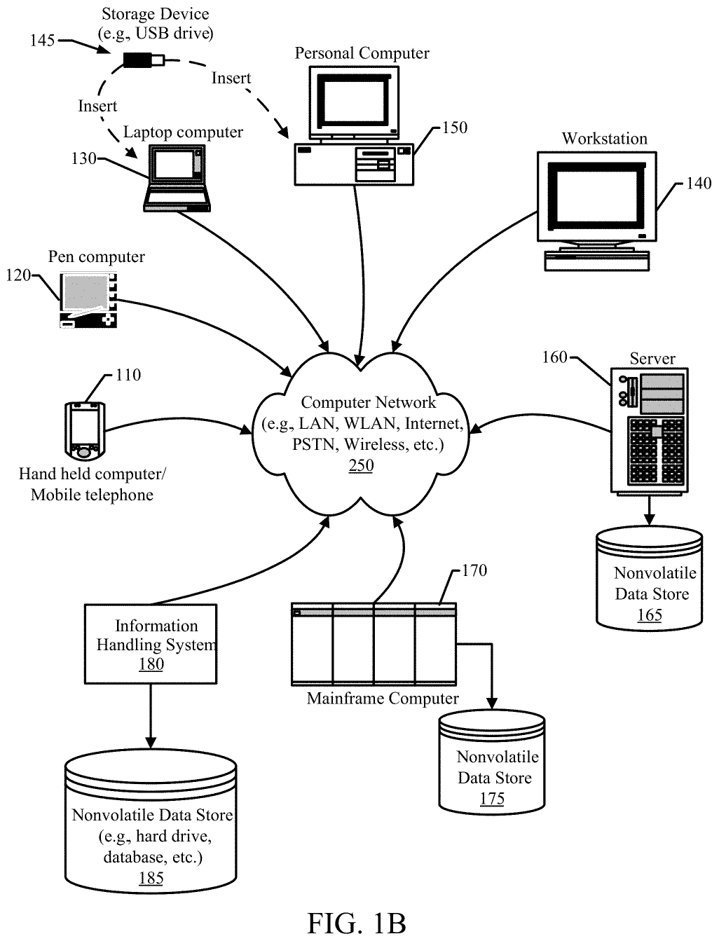

FIG. 1A illustrates a block diagram of an embodiment of a computing system 100, which may be a simplified example of a computing device (i.e., a physical bare metal system or virtual system) capable of performing the computing operations described herein. Computing system 100 may be representative of the one or more computing systems or devices implemented in accordance with the embodiments of the present disclosure and further described below in detail. It should be appreciated that FIG. 1A provides only an illustration of one implementation of a computing system 100 and does not imply any limitations regarding the environments in which different embodiments may be implemented. In general, the components illustrated in FIG. 1A may be representative of any electronic device, either physical or virtualized, capable of executing machine-readable program instructions.

Although FIG. 1A shows one example of a computing system 100, a computing system 100 may take many different forms, including bare metal computer systems, virtualized computer systems, container-oriented architecture, microservice-oriented architecture, etc. For example, computing system 100 can take the form of real or virtualized systems, including but not limited to desktop computer systems, laptops, notebooks, tablets, servers, client devices, network devices, network terminals, thin clients, thick clients, kiosks, mobile communication devices (e.g., smartphones), multiprocessor systems, microprocessor-based systems, minicomputer systems, mainframe computer systems, smart devices, and/or Internet of Things (IoT) devices. The computing systems 100 can operate in a local computing environment, networked computing environment, a containerized computing environment comprising one or more pods or clusters of containers, and/or a distributed cloud computing environment, which can include any of the systems or devices described herein and/or additional computing devices or systems known or used by a person of ordinary skill in the art.

Computing system 100 may include communications fabric 112, which can provide for electronic communications among one or more processor(s) 103, memory 105, persistent storage 106, cache 107, communications unit 111, and one or more input/output (I/O) interface(s) 115. Communications fabric 112 can be implemented with any architecture designed for passing data and/or controlling information between processor(s) 103 (such as microprocessors, CPUs, and network processors, etc.), memory 105, external devices 117, and any other hardware components within a computing system 100. For example, communications fabric 112 can be implemented as one or more buses, such as an address bus or data bus.

Memory 105 and persistent storage 106 may be computer-readable storage media. Embodiments of memory 105 may include random access memory (RAM) and/or cache 107 memory. In general, memory 105 can include any suitable volatile or non-volatile computer-readable storage media and may comprise firmware or other software programmed into the memory 105. Program(s) 114, application(s), processes, services, and installed components thereof, described herein, may be stored in memory 105 and/or persistent storage 106 for execution and/or access by one or more of the respective processor(s) 103 of the computing system 100.

Persistent storage 106 may include a plurality of magnetic hard disk drives, solid-state hard drives, semiconductor storage devices, read-only memories (ROM), erasable programmable read-only memories (EPROM), flash memories, or any other computer-readable storage media that is capable of storing program instructions or digital information. Embodiments of the media used by persistent storage 106 can also be removable. For example, a removable hard drive can be used for persistent storage 106. Other examples include optical and magnetic disks, thumb drives, and smart cards that are inserted into a drive for transfer onto another computer-readable storage medium that is also part of persistent storage 106.

Communications unit 111 provides for the facilitation of electronic communications between computing systems 100. For example, between one or more computer systems or devices via a communication network. In the exemplary embodiment, communications unit 111 may include network adapters or interfaces such as a TCP/IP adapter cards, wireless interface cards, or other wired or wireless communication links. Communication networks can comprise, for example, copper wires, optical fibers, wireless transmission, routers, load balancers, firewalls, switches, gateway computers, edge servers, and/or other network hardware which may be part of, or connect to, nodes of the communication networks including devices, host systems, terminals or other network computer systems. Software and data used to practice embodiments of the present disclosure can be downloaded to the computing systems 100 operating in a network environment through communications unit 111 (e.g., via the Internet, a local area network, or other wide area networks). From communications unit 111, the software and the data of program(s) 114 or application(s) can be loaded into persistent storage 116.

One or more I/O interfaces 115 may allow for input and output of data with other devices that may be connected to computing system 100. For example, I/O interface 115 can provide a connection to one or more external devices 117 such as one or more smart devices, IoT devices, recording systems such as camera systems or sensor device(s), input devices such as a keyboard, computer mouse, touch screen, virtual keyboard, touchpad, pointing device, or other human interface devices. External devices 117 can also include portable computer-readable storage media such as, for example, thumb drives, portable optical or magnetic disks, and memory cards. I/O interface 115 may connect to human-readable display 118. Human-readable display 118 provides a mechanism to display data to a user and can be, for example, computer monitors or screens. For example, by displaying data as part of a graphical user interface (GUI). Human-readable display 118 can also be an incorporated display and may function as a touch screen, such as a built-in display of a tablet computer.

FIG. 1B provides an extension of the computing system 100 environment shown in FIG. 1A to illustrate that the methods described herein can be performed on a wide variety of computing systems that operate in a networked environment. Types of computing systems 100 may range from small handheld devices, such as handheld computer/mobile telephone 110 to large mainframe systems, such as mainframe computer 170. Examples of handheld computer 110 include personal digital assistants (PDAs), personal entertainment devices, such as Moving Picture Experts Group Layer-3 Audio (MP3) players, portable televisions, and compact disc players. Other examples of information handling systems include pen, or tablet, computer 120, laptop, or notebook, computer 130, workstation 140, personal computer system 150, and server 160. Other types of information handling systems that are not individually shown in FIG. 1B are represented by information handling system 180. As shown, the various computing systems 100 can be networked together using computer network 250. Types of computer network 250 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the computing systems 100. Many of the computing systems include nonvolatile data stores, such as hard drives and/or nonvolatile memory. The embodiment of the information handling system shown in FIG. 1B includes separate nonvolatile data stores (more specifically, server 160 utilizes nonvolatile data store 165, mainframe computer 170 utilizes nonvolatile data store 175, and information handling system 180 utilizes nonvolatile data store 185). The nonvolatile data store can be a component that is external to the various computing systems or can be internal to one of the computing systems. In addition, removable nonvolatile storage device 145 can be shared among two or more computing systems using various techniques, such as connecting the removable nonvolatile storage device 145 to a USB port or other connector of the computing systems.

System for Implementing Change Detection and Versioning of Machine Learning Models

It will be readily understood that the instant components, as generally described and illustrated in the Figures herein, may be arranged and designed in a wide variety of different configurations. Accordingly, the following detailed description of the embodiments of at least one of a method, apparatus, non-transitory computer readable medium and system, as represented in the attached Figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Accordingly, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the Figures, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

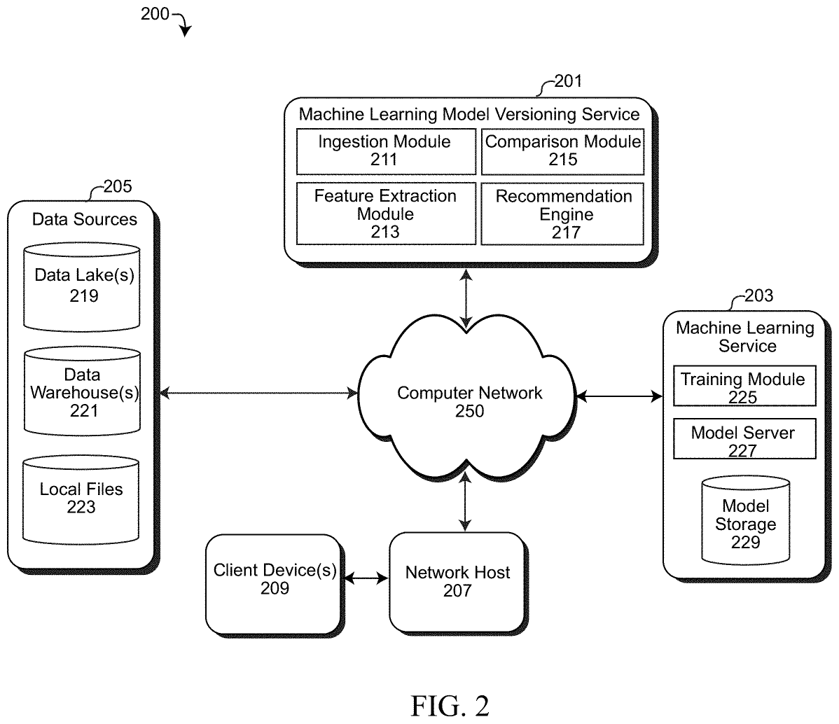

Referring to the drawings, FIG. 2 depicts an embodiment of a computing environment 200 comprising one or more computing systems 100 and variations thereof, to implement systems, methods, and computer program products for versioning machine learning models, detecting changes in feature between datasets used by the machine learning models, and recommending whether or not to re-train machine learning models depending on whether concept drift is detected that might render the machine learning model less accurate or obsolete if re-training does not occur. Embodiments of computing environment 200 may include one or more computing systems 100 interconnected via a computer network 250. In the exemplary embodiments depicted in FIG. 2 the computing systems 100 connected to the computing network 250 may be specialized systems or devices that may include, but are not limited to, the interconnection of one or more network host 207, client device(s) 209, and nodes hosting or maintaining data sources 205, machine learning model versioning service 201 (referred to hereinafter as “versioning service 201”), and machine learning service 203. While network host 207, client device(s) 209, and nodes hosting or maintaining data sources 205, versioning service 201 and machine learning service 203 may be interconnected via a network 250, other types of computing systems and devices known or used by a person skilled in the art, may be interconnected as well and/or may be substituted for the computing systems depicting in the Figures.

Embodiments of the specialized computing systems or devices exemplified in FIG. 2 may not only comprise the elements and components of the systems and devices depicted in FIG. 2 as shown, but the specialized computing systems depicted may further incorporate one or more elements or components of computing system 100 shown in FIG. 1A and described above. Although not shown in the Figures, one or more elements of computing system 100 may be integrated into the embodiments of network host 207, client device(s) 209, and nodes hosting or maintaining data sources 205, versioning service 201 and/or machine learning service 203, wherein the components integrated into the specialized computing systems include (but are not limited to) one or more processor(s) 103, program(s) 114, memory 105, persistent storage 106, cache 107, communications unit 111, I/O interface(s) 115, external device(s) 117 and human-readable display 118.

Embodiments of the network 250 connecting the network host 207, client device(s) 209, and nodes hosting or maintaining data sources 205, versioning service 201 and machine learning service 203 may be constructed using wired, wireless or fiber-optic connections. The network host 207, client device(s) 209, and nodes hosting or maintaining data sources 205, versioning service 201 and machine learning service 203, whether real or virtualized, may communicate over the network 250 via a communications unit 111, such as a network interface controller, network interface card, network transmitter/receiver or other network communication device capable of facilitating communication across the network. In some embodiments of computing environment 200, network host 207, client device(s) 209, and nodes hosting or maintaining data sources 205, versioning service 201 and/or machine learning service 203 may represent computing systems 100 utilizing clustered computing and components acting as a single pool of seamless resources when accessed through network by one or more user device(s). For example, such embodiments can be used in a datacenter, cloud computing network, storage area network (SAN), and network-attached storage (NAS) applications.

Embodiments of the communications unit 111 such as the network transmitter/receiver may implement specialized electronic circuitry, allowing for communication using a specific physical layer and a data link layer standard. For example, Ethernet, Fiber channel, Wi-Fi or other wireless radio transmission signals, cellular transmissions or Token Ring to transmit data between network host 207, client device(s) 209, and nodes hosting or maintaining data sources 205, versioning service 201 and machine learning service 203. Communications unit 111 may further allow for a full network protocol stack, enabling communication over a network to groups of computing systems 100 linked together through communication channels of the network. The network may facilitate communication and resource sharing among network host 207, client device(s) 209, and nodes hosting or maintaining data sources 205, versioning service 201 and machine learning service 203. Examples of the network may include a local area network (LAN), home area network (HAN), wide area network (WAN), backbone networks (BBN), peer to peer networks (P2P), campus networks, enterprise networks, the Internet, single tenant or multi-tenant cloud computing networks, wireless communication networks and any other network known by a person skilled in the art.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. A cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

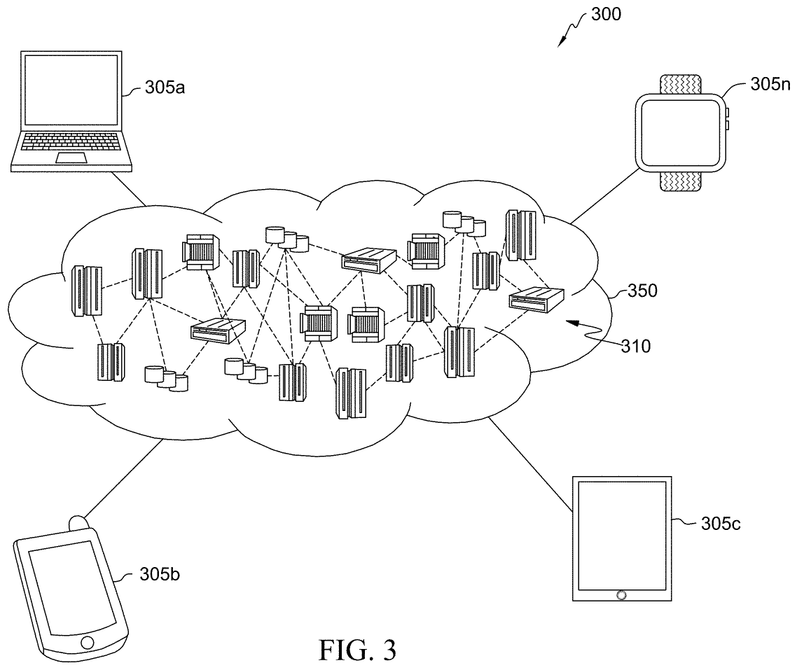

Referring to the drawings, FIG. 3 is an illustrative example of a cloud computing environment 300. As shown, cloud computing environment 300 includes a cloud network 350 comprising one or more cloud computing nodes 310 with which end user device(s) 305a-305n (referred to generally herein as end user device(s) 305) may be used by cloud consumers to access one or more software products, services, applications, and/or workloads provided by cloud service providers or tenants of the cloud network 350. Examples of the user device(s) 305 are depicted and may include devices such as a smartphone 305b or cellular telephone, desktop computers, laptop computer 305a, tablet computers 305c and smart devices such as a smartwatch 305n and smart glasses. Nodes 310 may communicate with one another and may be grouped (not shown) physically or virtually, in one or more networks, such as Private, Community, Public, or Hybrid clouds as described hereinabove, or a combination thereof. This allows cloud computing environment 300 to offer infrastructure, platforms and/or software as services for which a cloud consumer does not need to maintain resources on a local computing device. It is understood that the types of end user devices shown in FIG. 3 are intended to be illustrative only and that computing nodes 310 of cloud computing environment 300 can communicate with any type of computerized device over any type of network and/or network addressable connection (e.g., using a web browser).

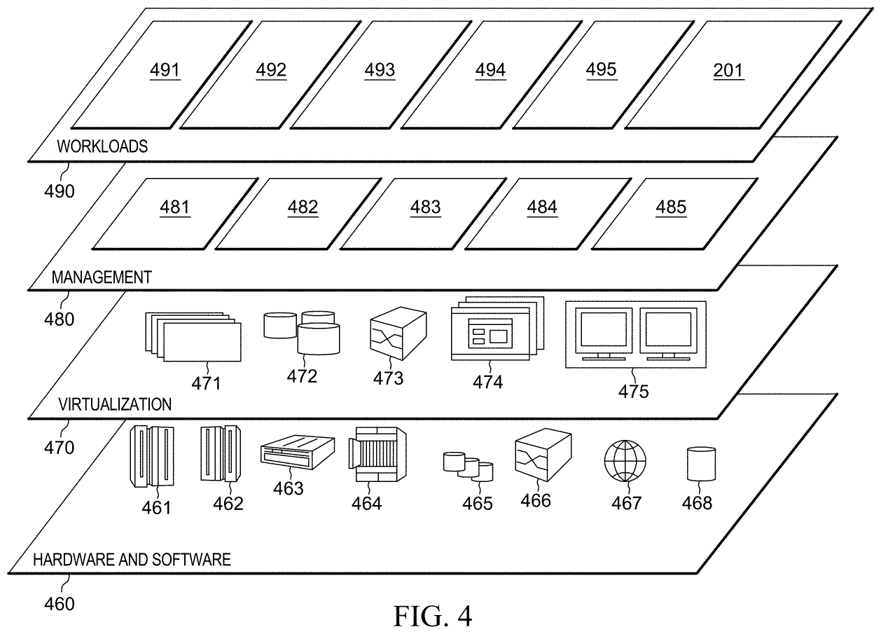

Referring now to FIG. 4, a set of functional abstraction layers provided by cloud computing environment 300 is shown. It should be understood in advance that the components, layers, and functions shown in FIG. 4 are intended to be illustrative only and embodiments of the invention are not limited thereto. As depicted, the following layers and corresponding functions are provided:

Hardware and software layer 460 includes hardware and software components. Examples of hardware components include mainframes 461; RISC (Reduced Instruction Set Computer) architecture-based servers 462; servers 463; blade servers 464; storage devices 465; and networks and networking components 466. In some embodiments, software components include network application server software 467 and database software 468.

Virtualization layer 470 provides an abstraction layer from which the following examples of virtual entities may be provided: virtual servers 471; virtual storage 472; virtual networks 473, including virtual private networks; virtual applications and operating systems 474; and virtual clients 475.

Management layer 480 may provide the functions described below. Resource provisioning 481 provides dynamic procurement of computing resources and other resources that are utilized to perform tasks within the cloud computing environment 300. Metering and pricing 482 provide cost tracking as resources are utilized within the cloud computing environment 300, and billing or invoicing for consumption of these resources. In one example, these resources can include application software licenses. Security provides identity verification for cloud consumers and tasks, as well as protection for data and other resources. User portal 483 provides access to the cloud computing environment 300 for consumers and system administrators. Service level management 484 provides cloud computing resource allocation and management such that required service levels are met. Service Level Agreement (SLA) planning and fulfillment 485 provide pre-arrangement for, and procurement of, cloud computing resources for which a future requirement is anticipated in accordance with an SLA.

Workloads layer 490 provides examples of functionality for which the cloud computing environment may be utilized. Examples of workloads and functions which may be provided from this layer include software development and lifecycle management 491, data analytics processing 492, multi-cloud management 493, transaction processing 494; database management 495 and machine learning model versioning service 201.

Referring back to the drawing of FIG. 2, the embodiment of the computing environment 200 presents a modular approach to training and re-training machine learning based models. Embodiments of the computing environment 200 include a machine learning based model versioning service 201 capable of determining whether a model requires versioning based on variations in the features of the datasets over time and the feature sets. Embodiments of the computing environment 200 may be part of a centralized or de-centralized network comprising a distribution of real or virtualized computing nodes communicating with one another across the network. A “node” of a network may refer to a connection point, redistribution point or a communication endpoint of the network. In the exemplary embodiment, computing environment 200 may comprise nodes such as versioning service 201, machine learning service 203, data sources 205, network host 207 and one or more client device(s) 209.

Embodiments of versioning service 201 may be responsible for performing feature exploration and extracting feature importance from current datasets used by the machine learning models, pre-processing new sets of features, compute changes between the features of the current datasets and the new datasets and perform feature correlation to determine whether or not to recommend re-training the machine learning model(s) with a set of features merged from the current dataset and/or the new dataset(s) that have changed or evolved over time. Embodiments of the various functions, tasks, processes, services and routines of the versioning service 201 being provided to customers, such as data managers and data mining users, may be performed by one or more components or modules of the versioning service 201. The term “module” may refer to a hardware module, software module, or a module may be a combination of hardware and software resources. Embodiments of hardware-based modules may include self-contained components such as chipsets, specialized circuitry, one or more memory 105 devices and/or persistent storage 106. A software-based module may be part of a program 114, program code or linked to program code containing specifically programmed instructions loaded into a memory 105 device or persistent storage 106 device of one or more specialized computing systems 100 operating as part of the computing environment 200. For instance, in the exemplary embodiment depicted in FIG. 2, versioning service 201 includes a plurality of components or modules, including (but not limited to) ingestion module 211, feature extraction module 213, comparison module 215 and/or recommendation engine 217.

Versioning service 201 may train a machine learning model using an input data set (M₁) being ingested from one or more data sources 205 by an ingestion module 211. Data sources 205 may be a place or location from which data for the input data set can be obtained. The source can be any data in any file format, so long as the ingestion module 211 or any other program of the versioning service 201 can understand how to read the data being ingested from the data sources 205. Embodiments of data sources can be a collection of records that store data, any document organized to provide structure for the ingestion module 211 receiving the pulled data from the data sources 205, any type of text file such as a plain text file or database file. In FIG. 2, examples of data sources 205 are shown and may include sources such as data lake(s) 219, data warehouse(s) 221 and/or local files 223 that may be stored by host devices running the versioning service 201, such as a server, mainframe or any other type of computing device.

Embodiments of the versioning service 201 may perform the functions of training the machine learning model or may subscribe to services provided by another node on the computing network 250 to train a machine learning model. For example, in the embodiment of the computing environment 200 depicted in FIG. 2, a separate machine learning service 203 comprising one or more components for training, storing and distributing machine learning models may be available for use or accessible by the versioning service 201. For example, training module 225 may train the machine learning model using one or more datasets from data sources 205 and training algorithms implemented by the training module 225. Model storage 229 may store the machine learning models trained by training module 225, while model server 227 may distribute the model to user and/customers as part of an application or workload, as a file, as part of a file library and/or as an application programming interface (API) which may separate the application from the model being deployed. In alternative embodiments, components of machine learning service 203 that may be responsible for the training, storage, and deployment of the trained models may be incorporated into the versioning service 201. For example, by incorporating the training module 225, model server 227 and/or model storage into the versioning service 201.

Embodiments of the feature extraction module 213 may perform functions tasks and processes associated with feature exploration and extraction of feature importance (f₁) from trained model(s) which may be influenced by the M₁ dataset used as the input dataset. Feature importance may refer to a class of techniques for assigning scores to input features found in datasets of predictive models. The assigned scores corresponding to feature importance indicate the relative importance of each feature when a prediction is made by the model. Feature importance scores may be calculated for problems that can involve predicting a numerical value (i.e., referred to as a regression) and problems that may involve predicting a class label (i.e., classification). Feature importance scores assigned to extracted features can help data scientists better understand the data of the datasets. The relative scores can highlight which features may be the most relevant to the target and conversely, which features are the least relevant. Moreover, feature importance scores can help provide insight into the model and/or help reduce the number of input features.

Embodiments of the feature extraction module 213 may extract feature importance f₁ of the trained model using one or more explainable AI, algorithms, or techniques. Explainable AI, such as a LIME framework, permutation importance, PDP and/or SHAP may be deployed by the versioning service 201 to quantify the feature importance f₁ for the features of the dataset being used by the model. For example, in some embodiments, LIME may be used to understand how features are correlated to one another, and feature importance, including both local and global importance of the features being extracted for evaluation. An explainable AI, such as LIME may be capable of explaining predictions of a classifier or other model, in an interpretable manner, allowing even non-experts to compare and improve models through feature engineering. LIME is model-agnostic and may be applied to any machine learning model. The technique of LIME attempts to understand the model by perturbing input of data samples and understanding how the predictions change as a result. For example, LIME may modify a single data sample by tweaking the feature values and observing the resulting impact on the output. The output from LIME may be a list of explanations reflecting the contribution of each extracted feature of the dataset to a prediction of a data sample, allowing local interpretability and allows data scientists to understand which feature changes will have the most impact on a prediction.

In addition to LIME, feature extraction module 213 may deploy other explanatory frameworks, techniques and/or algorithms for determining feature importance f₁ of the features extracted by the feature extraction module 213. For example, other possibilities may include (but are not limited to) permutation importance, PDP and SHAP. Permutation importance is another model-agnostic technique for determining variable importance of the model. Permutation importance does not require a single variable-related, discrete training process like a decision tree might. Permutation importance may start off by shuffling values within a single column of the dataset to prepare a “revised” dataset. Using the “revised” data, predictions are made using the existing model that has already been trained by versioning service 201 and/or machine learning service 203. Prediction accuracy using the “revised” data will be worse than the original unshuffled data and should experience an increase in loss function. The data of the dataset being shuffled may be returned to the original order, and the shuffling of the data is applied to the next column in the dataset. As the technique shuffles each column multiple times and records the increase in loss function, the importance of each variable can be calculated as well as the mean and standard deviation of permutation importance in order to identify features that are most important to least important.

While a variable importance technique, such as permutation importance, may provide one feature importance score per variable, partial dependence plot (PDP) can provide a curve representing how much a variable within the dataset affects the final prediction at a particular value range of the variable. The partial dependence plot is considered a global method. PDP considers all instances and gives statement about the global relationship of a feature with the predicted outcome. The flatter the curve of the PDP, the more the PDP indicates that a feature is not important, while the more a PDP varies, the more important the feature is. PDP can show the marginal effect one or two features may have on a predicted outcome of a machine learning model. A PDP may show whether the relationship between a target and a feature are linear, monotonic or more complex. For example, when applied to a linear regression, a PDP will always show a linear relationship. Whereas for classification, where a machine learning model outputs probabilities, the PDP displays the probability that for a certain class given different values for features within the dataset. When there are multiple classes, one line or plot per class may be drawn.

In some embodiments of the feature extraction module 213, feature importance f₁, for the dataset of the machine learning model may be computed using SHAP. SHAP explains a prediction of a particular instance by computing the contribution of each feature to the prediction. The SHAP explanation method computes Shapley values from coalitional game theory. Shapley values indicate the average marginal contribution of a feature across all possible combinations of features. The feature values of the data instance act as players in a coalition and the Shapley values inform how to fairly distribute the “payout” (the prediction) among the features. A “player” may be an individual feature value, for example a value found in tabular data. In other examples, the player can also be a group of feature values, for instance, when explaining an image, pixels can be grouped into super pixels, wherein the prediction can be distributed among the super pixels.

Embodiments of feature extraction module 213 may generate a listing or ranking of the top features of the extracted features f₁, based on feature importance as calculated and/or explained by the one or more explainable AI implemented by the feature extraction module 213 to compute feature importance. The list or ranking may order the extracted features by feature importance, wherein the highest ranked features have the highest impact on predictions and insights of the trained model, while the lowest ranked features have the least impact on predictions and insights being generated by the model. In some embodiments, feature extraction module 213 may further extract from the ranked listing of extracted features f₁, the top features of the ranked listing up to a configured threshold number of features (referred to herein as “the top n features”). The threshold may be selected by a user configuring one or more settings of the versioning service 201. The threshold number of features (n) may be an absolute number, such as extracting the top 3, top 5, top 10, etc., features from the ranked listing. In other embodiments, the threshold number of features (n) may be a percentage (i.e., n %) of features in the ranked listing. For example, configuring the feature extraction module to create the list of top features by extracting the top 5%, top 10%, top 20%, etc., of features from the ranked listing of features ranked in order by feature importance.

Over time, as new or updated datasets emerge and/or evolve. These new datasets may be ingested into the versioning service 201 by ingestion module 211 from one or more data sources 205. The newly ingested datasets received by the versioning service 201 can be pre-processed by the feature extraction module 213. The feature extraction module 213 may pre-process a new set of features (f₂) extracted from the new or evolved dataset. Embodiments of the versioning service 201 may compare the changes between the top n features extracted from feature set f₁ as configured based on the threshold with the pre-processed features f₂ from the new or evolved dataset.

Embodiments of the versioning service 201 may include a comparison module 215 which may perform functions or tasks of the versioning service 201 directed toward comparing the changes in features (i.e., the delta) between the features extracted from f₁ and the feature set f₂, for the top n features of the dataset used for the current machine learning model. During the comparison of the delta between features of f₁ and f₂ for the top n features being considered, if the feature set f₁ does not overlap with feature set f₂, comparison module 215 highlights the features of set (f₁−f₂) present in f₁ which have an addition or deletion of categories with the feature. Moreover, if the set (f₁−f₂) falls within the top n features of importance in f₁ for the model, the recommendation engine 217 of the versioning service 201 may output a recommendation to retrain the machine learning model. The recommendation of the recommendation engine 217 may be outputted to one or more client device(s) 209 and/or network host(s) 207 within computing environment 200 that may subscribe and/or access the services of the versioning service 201. Alternatively, if the comparison performed by the comparison module 215 finds that there is no change between f₁ and f₂ and/or the feature set (f₁-f₂) does not fall within the top n features of f₁, the top n features of f₁ may be stored in a feature store for later use, and output from recommendation engine 217 may indicate that re-training of the model is not required.

In some embodiments, the comparison module 215, while examining the differences between the feature sets of f₁ and f₂, may further consider whether the differences in features of the model's dataset, M₁, relative to the new or evolved dataset is indicative of semantical changes of a prior feature within the M₁ dataset. Rather than being an entirely new feature, the underlying concept represented within the new dataset might in fact be a feature of the M₁ dataset that has evolved over time.

For example, feature set f₂ may comprise a new feature representing a revised list of member countries that may be party to an agreement or treaty, which may include additional countries that may have ratified the treaty or terminated the treaty, whereas the initial feature set f₁ may be a prior list of countries, before new member countries joined, or existing members terminated their membership. In this example, the comparison module 215 may refer to a common geographical ontology to compute whether the new feature of f₂ is correlated with old features of set f₁ which may be considered a “revision” of the participating country list. Accordingly, as a result of the feature being a revised set of features that is more up to date than the original feature of f₁, it makes sense to substitute the country list of f₂ and re-train the model to better account for the current state of features. Moreover, the use of feature substitution may be performed even if statistically the new feature of set f₂ is closely overlapping the prior feature of set f₁ (i.e., only one country added or removed from the treaty membership). For instance, in the agreement between countries example, even if only one country is added or removed between a first dataset and a second dataset, the change in party membership in this example implies a major drift in terms of semantics and interpretation of the problem domain, Therefore re-training should occur. Alternatively, in some instances, the versioning service 201 may discover that feature augmentation may be more appropriate than feature substitution, whereby useful information of the model dataset is combined with new features of the new dataset which may lead to improved predictions and performance once the model is re-trained using the augmented dataset. The inference may be made based on relationships between features inferred by referring to relationships within a domain ontology.

In addition to delivering recommendations of whether or not to retrain the machine learning model as described above, embodiments of the recommendation engine 217 may further perform functions or tasks of the versioning service 201 which may be directed toward feature correlation between new data sets with attributes not previously found within the feature set f₁. To identify feature correlation, recommendation engine 217 may generate a correlation matrix between previous sets of features f₁ and the new features present in set f₂ and utilize cosine similarity and vector distance, and/or semantic distance in order to determine whether not the model should be recommended for retraining. For example, in some embodiments, cosine similarity and vector distance may be calculated between the top n features of set f₁ and the new features f₂. Feature overlap may be represented by the vector distance, wherein if the vector distance is significant, no model training may be recommended because there is less correlation between the features. Likewise, when the vector distance is insignificant or non-existence (null), then a recommendation for re-training the model may be outputted by the recommendation engine 217. In some embodiments, feature overlap can be computed using semantic distance to determine whether or not new features of set f₂ are considered to be a time-revised concept over original features within set f₁. If semantic overlap is true based on the computed semantic distance, recommendation engine 217 may output a recommendation to retrain the model to include the new features of set f₂ which may be merged with the features of set f₁. However, if the feature overlap is false based on the computed semantic distance, recommendation engine 217 may not recommend re-training the machine learning model.

Experimental Example Using the Versioning Service

The versioning service was applied on a risk analytic model in the field of global IT services. The trained risk analytic model provided risk insights on real-world contracts and invoice data. The machine learning model based versioning service was implemented to recommend whether new features in contracts and invoice data required model re-training. During the experiment, a set of 900 contract orders were selected from a repository of contracts. Invoices for the 900 contracts were analyzed, which totaled more than one million records to develop a repository mapping contracts to invoices.

The contract and invoices dataset were trained using time series prophet forecasting model and calculated risk for every contract. The top five features were extracted using the LIME framework. The features included contract duration, billing frequency, contract amount, invoice amount and customer usage trend. This feature set was labeled as f₁. The target variable was the risk score of the contract.

In the first scenario, additional invoices were received for the contracts from which the features f₂ were extracted. The top features were identified and the delta changes between (f₁, f₂) were found. The delta changes involve new invoice amounts for the contract. The Pearson correlation metrics algorithm outputs the correlation of invoice amounts with the feature set f₂. Since the cosine similarity and vector distance between invoice amount and our target variable risk score was 0.8, which is near a high correlation score, the recommendation engine outputs retraining the model to include the new invoices for the contracts. Sample risk analytics were outputted for a contract if the recommendation for merging additional features was not taken into consideration. We observed that the actual risk varies from the predicted risk in the last few billing cycles.

In the second scenario, we received new contracts for evaluation. There were no matching invoices yet for these contracts since they had just been initiated. The features f₂ had missing data for the top features in f₁. Hence, the delta changes between (f₁, f₂) would have no improvement over the already trained risk analytics model. As a result, the recommendation was not to immediately retrain the model, and merge the additional features from the new data set.

Method for Implementing Change Detection and Versioning of Machine Learning Models

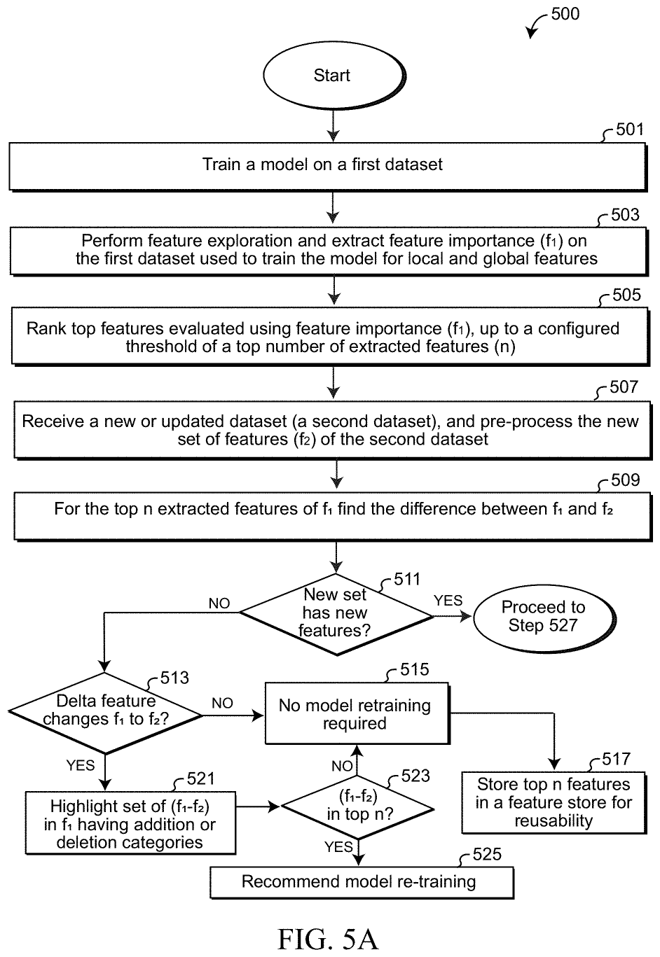

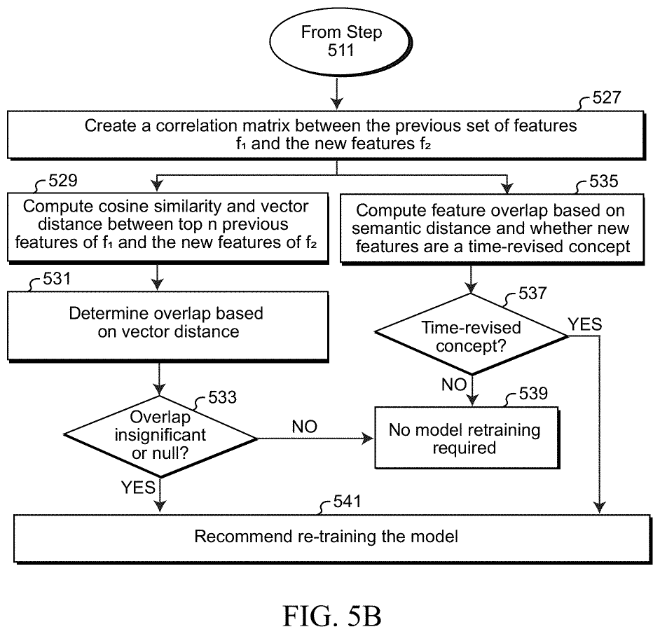

The drawings of FIGS. 5A-5B represent embodiments of methods for implementing change detection and versioning of machine learning models, as described in accordance with FIGS. 2-4 above, using one or more computing systems defined generically by computing system 100 of FIGS. 1A-1B; and more specifically by the embodiments of specialized computer systems depicted in FIGS. 2-4 and as described herein. A person skilled in the art should recognize that the steps of the method described in FIGS. 5A-5B may be performed in a different order than presented and may not require all the steps described herein to be performed.

FIG. 5A may refer to a method 500 for performing change detection and versioning of machine learning modes. The embodiment of the method 500 may begin at step 501. During step 501, a machine learning model may be trained and developed using a first dataset. Training of the model may be performed by the versioning service 201 itself in some embodiments. For example, where the versioning services is equipped with components for training a model, such as a training module 225, model server 227 and/or model storage 229. Otherwise, in embodiments where the versioning service 201 does not include actual components for training the model itself using the first dataset, a machine learning service 203 may be deployed to train the model.

In step 503, ingestion module 211 of the versioning service 201 may ingest the first dataset used to train the model. The dataset may be retrieved from a storage location, such as one or more data sources 205, including one or more data lake(s) 219, data warehouse(s) 221 and/or from local files 223. A feature extraction module 213 of the versioning service 201 may perform feature exploration and extract feature importance, f₁, of the trained model using an explainable AI. The explainable AI extracting feature importance, f₁, may extract local and/or global importance of features. In the exemplary embodiments, a LIME framework may be used as the explainable AI performing the feature extraction. In alternative embodiments, different explainable AI and algorithms may be used separately and/or in conjunction with LIME or each other. For example, embodiments may perform feature extraction of the trained model using permutation importance, PDP, and/or SHAP. In step 505, the most important features may be identified by the explainable AI, by ranking top features using feature importance (f₁) and taking the top number of ranked features up to a configured threshold number (n) of features or percentage of the total features extracted.

In step 507, versioning service 201 may receive and/or ingest a new or updated dataset (i.e., a second dataset). The second dataset may be received from one or more data sources 205 and ingested into the versioning service 201 via the ingestion module 211. Embodiments of the versioning service 201 may pre-process a new set of features (f₂) from the new or evolved second dataset. Using the feature set f₂, in step 509, the difference (the delta) between f₁ and f₂ can be found for the top n or n % extracted features of f₁. In step 511, a determination may be made whether the second dataset is a new dataset comprising feature set f₂ with attributes that are not previously present within the feature set of f₁. If the new features are found within f₂ that have attributes not present within f₁, the method 500 may proceeds to step 527. Otherwise, if the second dataset does not comprise a new feature set with attributes that were not previously in f₁, the method 500 may proceed to step 513.

In step 513, versioning service 201 may determine, based on the comparison between f₁ and f₂ for the top n extracted features of f₁, whether there is a delta between the features in f₁ and f₂. If there is no delta between the features of f₁ and f₂, the method may proceed to step 515, wherein recommendation engine 217 outputs a recommendation not to re-train the model, and in step 517 store the top n features in a feature store for subsequent reusability at a later point in time. Conversely, if the determination is made in step 513 that a delta exists between the features of f₁ and f₂ for the top n features of f₁, the method may proceed to step 521. In step 521, for non-overlapping features between f₁ and f₂, the feature set of (f₁−f₂) is highlighted for features in f₁ which comprise an addition or deletion of categories within the feature. Moreover, while examining differences between the features sets of f₁ and f₂, consideration for whether or not differences between the second dataset and the first dataset indicate semantical changes within a prior feature of f₁, indicating whether or not a feature of f₁ may be different because the feature has evolved over time into the feature of f₂. For example, revisions to the first dataset that would substitute the original feature in f₁ for the revised feature found in f₂ and/or augment the feature in f₁ to reflect the feature found in f₂. Where substitutions and augmentations to the feature sets from f₁ to f₂ are found, re-training the model may be recommended by the recommendation engine 217.

In step 523, a determination is made whether or not the feature set (f₁−f₂), which comprises additions or deletions of categories within the feature set of f₁. If the feature set (f₁−f₂) is within the threshold number of top n features, the method may proceed to step 525, wherein recommendation engine 217 outputs a recommendation to re-train the machine learning model. Moreover, where the highlighted feature set (f₁−f₂) are not present within the threshold number of top n features of the extracted feature set f₁, the method 500 may proceed to step 515, wherein recommendation engine 217 may output a recommendation not to re-train the model.

Referring to the drawing of FIG. 5B, method 500 may continue from step 511 to step 527 as described above, wherein the second dataset is found to comprise new data having a new feature set with attributes not previously found in the feature set of f₁. In step 527, recommendation engine 217 may create a correlation matrix between the previous set of features within feature set f₁ and the new features of feature set f₂. From step 527, method 500 may proceed to step 529 in some embodiments and perform the steps 529, 531 and 533. In other embodiments, method 500 may proceed to step 535 and 537. Embodiments of method 500 may perform steps 529, 531 and 533 in sequence followed by 535 and 537, or vice versa wherein 535 and 537 are performed first, followed by 529, 531 and 533. In the exemplary embodiment of FIG. 5B, method 500 is depicted as performing steps 529, 531 and 533 in parallel with steps 535, and 537.

In step 529, recommendation engine 217 may compute cosine similarity and vector distance between the configured threshold number (n) of top features within f₁, and the new feature found in feature set f₂. In step 531, the feature overlap between f₁ and f₂ are computed based on vector distance calculated in step 529. In step 533, a determination is made based on the overlap of the vector distance whether or not to re-train the machine learning model, based on the significance of the overlap. If the overlap is insignificant, or non-existent (i.e., null) the method 500 may proceed to step 541, whereby the recommendation engine 217 may recommend re-training the machine learning model, since there is feature correlation between the new features of f₂ having a feature set with attributes not previously found in f₁. Likewise, if the vector distance between f₁ and f₂ is significant, model training may not be recommended since there is considered less correlation between the features of f₁ and the new features of f₂.

In step 535, feature overlap between features of f₁ and f₂ may be determined by computing semantic distance. The use of semantic distance may indicate whether the new features present in feature set f₂ represent a time-revised concept that is more up to date over the original feature(s) that are a part of feature set f₁. If semantic distance indicates the new feature in feature set f₂ is a time-revised concept for a feature of feature set f₁, method 500 may proceed to step 541, wherein recommendation engine 217 outputs a recommendation to re-train the machine learning model using the new dataset. Moreover, if in step 537, the computed semantic distance does not indicate that the new feature set f₂ is a time-revised concept of a feature in f₁, the method 500 may proceed to step 539, wherein recommendation engine 217 outputs a recommendation not to re-train the machine learning model.

What is claimed is:

1. A computer-implemented method for versioning a machine learning model, the computer-implemented method comprising:
ingesting, by a versioning service, a first dataset configured to train the machine learning model;
performing, by the versioning service, feature exploration of the first data set and extracting from the first dataset, feature importance (f₁) of the machine learning model;
ranking, by the versioning service, top features of the first dataset used to train the machine learning model by the feature importance, up to a configured threshold number (n) of features;
pre-processing, by the versioning service, features of a second dataset (f₂);
comparing, by the versioning service, changes in features between f₁ and f₂ for up to the configured threshold number of features; and
upon comparing, by the versioning service, the changes in the features between f₁ and f₂, and the changes between f₁ and f₂ are non-overlapping features:
highlighting set (f₁−f₂) in f₁ which have an addition or deletion of categories within a feature and if the set (f₁−f₂) is ranked within the top features up to the configured threshold number of features for f₁, outputting, by the versioning service, a recommendation to re-train the machine learning model.

2. The computer-implemented method of claim 1, further comprising:
upon comparing, by the versioning service, the changes in the features between f₁ and f₂, the changes between f₁ and f₂ are non-overlapping features and the set (f₁−f₂) is not ranked within the top features up to the configured threshold number of features for f₁, storing, by the versioning service, the top features up to the configured threshold number of features in a feature store.

3. The computer-implemented method of claim 1, further comprising:
upon comparing, by the versioning service, the changes in features between f₁ and f₂, and finding no change in the features between f₁ and f₂ within the top features up to the configured threshold number of features, outputting by the versioning service, a recommendation that re-training of the machine learning model is not required.

4. The computer-implemented method of claim 1, wherein upon comparing, by the versioning service, changes in features between f₁ and f₂, the second data set includes a new feature set with attributes absent from f₁, the computer-implemented method further comprises:
creating, by the versioning service, a correlation matrix between f₁ and the new feature set of f₂ having the attributes that are absent from f₁.

5. The computer-implemented method of claim 4 further comprising:
computing, by the versioning service, cosine similarity and vector distance between the features of f₁ and the new feature set of f₂ having the attributes that are absent from f₁;
determining, by the versioning service, an amount of overlap in the vector distance between the top features of f₁ up to the configured threshold number of features and the new feature set of f₂; and
wherein upon the overlap in vector distance is insignificant or null, outputting, by the versioning service, a recommendation to re-train the machine learning model.

6. The computer-implemented method of claim 4, further comprising:
computing, by the versioning service, semantic distance between the features of f₁ and the new feature set of f₂, wherein overlap in the semantic distance between features of importance within f₁ and the new feature set of f₂ indicates a time-revised concept in f₂ over an original feature in f₁; and
upon identifying the time revised concept in f₂ over the original feature in f₁, outputting, by the versioning service, a recommendation to re-train the machine learning model.

7. The computer-implemented method of claim 1, wherein recommending, by the versioning service to re-train the machine learning model, includes re-training the machine learning model using a merged set of top features comprising features of importance from f₁ and f₂ up to the configured threshold number of features.

8. A computer program product for versioning a machine learning model comprising:
one or more computer readable storage media having computer-readable program instructions stored on the one or more computer readable storage media, said program instructions executes a computer-implemented method comprising:
ingesting, by a versioning service, a first dataset configured to train the machine learning model;
performing, by the versioning service, feature exploration of the first data set and extracting from the first dataset, feature importance (f₁) of the machine learning model;
ranking, by the versioning service, top features of the first dataset used to train the machine learning model by the feature importance, up to a configured threshold number (n) of features;
pre-processing, by the versioning service, features of a second dataset (f₂);
comparing, by the versioning service, changes in features between f₁ and f₂ for up to the configured threshold number of features; and
upon comparing, by the versioning service, the changes in the features between f₁ and f₂, and the changes between f₁ and f₂ are non-overlapping features:
highlighting set (f₁−f₂) in f₁ which have an addition or deletion of categories within a feature and if the set (f₁−f₂) is ranked within the top features up to the configured threshold number of features for f₁, outputting, by the versioning service, a recommendation to re-train the machine learning model.

9. The computer program product of claim 8, further comprising:
upon comparing, by the versioning service, the changes in the features between f₁ and f₂, the changes between f₁ and f₂ are non-overlapping features and the set (f₁−f₂) is not ranked within the top features up to the configured threshold number of features for f₁, storing, by the versioning service, the top features up to the configured threshold number of features in a feature store.

10. The computer program product of claim 8, further comprising:
upon comparing, by the versioning service, the changes in features between f₁ and f₂, and finding no change in the features between f₁ and f₂ within the top features up to the configured threshold number of features, outputting by the versioning service, a recommendation that re-training of the machine learning model is not required.

11. The computer program product of claim 8, wherein upon comparing, by the versioning service, changes in features between f₁ and f₂, the second data set includes a new feature set with attributes absent from f₁, the computer-implemented method further comprises:
creating, by the versioning service, a correlation matrix between f₁ and the new feature set of f₂ having the attributes that are absent from f₁.

12. The computer program product of claim 11, further comprising:
computing, by the versioning service, cosine similarity and vector distance between the features of f₁ and the new feature set of f₂ having the attributes that are absent from f₁;
determining, by the versioning service, an amount of overlap in the vector distance between the top features of f₁ up to the configured threshold number of features and the new feature set of f₂; and
wherein upon the overlap in vector distance is insignificant or null, outputting, by the versioning service, a recommendation to re-train the machine learning model.

13. The computer program product of claim 11, further comprising:
computing, by the versioning service, semantic distance between the features of f₁ and the new feature set of f₂, wherein overlap in the semantic distance between features of importance within f₁ and the new feature set of f₂ indicates a time-revised concept in f₂ over an original feature in f₁; and
upon identifying the time revised concept in f₂ over the original feature in f₁, outputting, by the versioning service, a recommendation to re-train the machine learning model.

14. The computer program product of claim 8, wherein recommending, by the versioning service to re-train the machine learning model, includes re-training the machine learning model using a merged set of top features comprising features of importance from f₁ and f₂ up to the configured threshold number of features.

15. A computer system for versioning a machine learning model comprising:
a processor; and
a computer-readable storage media coupled to the processor, wherein the computer-readable storage media contains program instructions executing a computer-implemented method comprising:
ingesting, by a versioning service, a first dataset configured to train the machine learning model;
performing, by the versioning service, feature exploration of the first data set and extracting from the first dataset, feature importance (f₁) of the machine learning model;
ranking, by the versioning service, top features of the first dataset used to train the machine learning model by the feature importance, up to a configured threshold number (n) of features;
pre-processing, by the versioning service, features of a second dataset (f₂);
comparing, by the versioning service, changes in features between f₁ and f₂ for up to the configured threshold number of features; and
upon comparing, by the versioning service, the changes in the features between f₁ and f₂, and the changes between f₁ and f₂ are non-overlapping features:
highlighting set (f₁−f₂) in f₁ which have an addition or deletion of categories within a feature and if the set (f₁−f₂) is ranked within the top features up to the configured threshold number of features for f₁, outputting, by the versioning service, a recommendation to re-train the machine learning model.

16. The computer system of claim 15, further comprising:
upon comparing, by the versioning service, the changes in the features between f₁ and f₂, the changes between f₁ and f₂ are non-overlapping features and the set (f₁−f₂) is not ranked within the top features up to the configured threshold number of features for f₁, storing, by the versioning service, the top features up to the configured threshold number of features in a feature store.

17. The computer system of claim 15, wherein upon comparing, by the versioning service, changes in features between f₁ and f₂, the second data set includes a new feature set with attributes absent from f₁, the computer-implemented method further comprises:
creating, by the versioning service, a correlation matrix between f₁ and the new feature set of f₂ having the attributes that are absent from f₁.

18. The computer system of claim 17, further comprising:
computing, by the versioning service, cosine similarity and vector distance between the features of f₁ and the new feature set of f₂ having the attributes that are absent from f₁;
determining, by the versioning service, an amount of overlap in the vector distance between the top features of f₁ up to the configured threshold number of features and the new feature set of f₂; and
wherein upon the overlap in vector distance is insignificant or null, outputting, by the versioning service, a recommendation to re-train the machine learning model.

19. The computer system of claim 17, further comprising:
computing, by the versioning service, semantic distance between the features of f₁ and the new feature set of f₂, wherein overlap in the semantic distance between features of importance within f₁ and the new feature set of f₂ indicates a time-revised concept in f₂ over an original feature in f₁; and
upon identifying the time revised concept in f₂ over the original feature in f₁, outputting, by the versioning service, a recommendation to re-train the machine learning model.

20. The computer system of claim 15, wherein recommending, by the versioning service to re-train the machine learning model, includes re-training the machine learning model using a merged set of top features comprising features of importance from f₁ and f₂ up to the configured threshold number of features.
